(19) United States
(12) Patent Application Publication
(10) Pub. No.: US 2008/0018593 A1
(43) Pub. Date: Jan. 24, 2008

(54) IMAGE FORMING CONTROL APPARATUS AND CONTROL METHOD THEREOF

(75) Inventors: Sang-jin Park, Suwon-si (KR); Jun-young Choi, Suwon-si (KR)

Correspondence Address: STANZIONE & KIM, LLP, 919 18TH STREET, N.W., SUITE 440, WASHINGTON, DC, 20006, US

(73) Assignee: Samsung Electronics Co., Ltd., Suwon-si (KR)

(21) Appl. No.: 11/780,565

(22) Filed: Jul. 20, 2007

(30) Foreign Application Priority Data
Jul. 24, 2006 (KR) 2006-69311

(51) Int. Cl. G09G 5/00

(52) U.S. Cl. 345/156

(57) ABSTRACT

An image forming control apparatus includes a display unit, a user input unit that allows a user to move a pointer on a picture displayed on the display unit, a printer driver that includes a setup information storing unit in which setup information for a plurality of setup items related to image formation is stored, and drives an image forming apparatus based on the setup information, and a controller to control a setup information initial picture having a plurality of individual selection areas for the plurality of setup items to be displayed on the display unit, and causes details of the setup information for a relevant setup item to be displayed in a pop-up picture of a predetermined format on the display unit if the user places the pointer on one of the plurality of individual selection areas through the user input unit.

### CROSS-REFERENCE TO RELATED APPLICATIONS

This application claims priority under 35 U.S.C. § 119(a) from Korean Patent Application No. 2006-0069311, filed on Jul. 24, 2006, the disclosure of which is incorporated herein by reference in its entirety.

### BACKGROUND OF THE INVENTION

1. Field of the Invention

The present general inventive concept relates to an image forming control apparatus and a control method thereof, and more particularly, to an image forming control apparatus which is capable of displaying setup information on a plurality of setup items related to image formation for a user, and a control method thereof.

2. Description of the Related Art

An image forming control apparatus drives an image forming apparatus through an interface. In particular, a print driver of the image forming control apparatus converts a document created in an application program into print data recognizable by the image forming apparatus, and provides a user interface (UI) to allow a user to set setup information related to image formation, for example, the number of prints, the kind of paper, printing direction, print quality, etc.

Specifically, when a document is to be printed, the print driver of the image forming control apparatus provides a basic UI picture for setup information related to image formation, and a user selects or changes the setup information through the basic UI picture. Then, the image forming apparatus prints the document based on the setup information selected or changed by the user.

In recent years, as more setup information related to image formation has been provided, the UI picture configuration of the print driver are getting more complicated. Therefore, if a user does not know the location of the setup information to change, the user has to select functions of the UI picture one by one to search for the set information. This is not an efficient use of the time and effort on the part of the user.

### SUMMARY OF THE INVENTION

The present general inventive concept provides an image forming control apparatus which is capable of simply and quickly displaying setup information for a plurality of setup items related to image formation for a user, and a control method thereof.

The present general inventive concept provides an image forming control apparatus which is capable of allowing a user to change setup information of a driver in a preview function, and a control method thereof.

Additional aspects and utilities of the present general inventive concept will be set forth in part in the description which follows and, in part, will be obvious from the description, or may be learned by practice of the general inventive concept.

The foregoing and/or other aspects and utilities of the present general inventive concept can be achieved by providing an image forming control apparatus including a display unit, a user input unit that allows a user to move a pointer on a picture displayed on the display unit, a printer driver that includes a setup information storing unit to store setup information for a plurality of setup items related to image formation, and to drive an image forming apparatus based on the setup information, and a controller to control a setup information initial picture having a plurality of individual selection areas for the plurality of setup items to be displayed on the display unit, and to control details of the setup information corresponding to a setup item to be displayed in a pop-up picture of a predetermined format on the display unit if the user places the pointer on one of the plurality of individual selection areas through the user input unit.

The controller causes the pop-up picture to be removed if the user moves the pointer out of the individual selection area on which the pointer has been placed.

The pop-up picture further includes a setup change area in which the user changes the setup information for the setup item through the user input unit.

The controller further comprises a view storing unit, and, if the user changes the setup information in the setup change area, the controller stores the changed setup information in the view storing unit.

The controller causes a message to request a confirmation for the change of the setup information to be displayed on the display unit, and, if the user selects the confirmation through the user input unit, the controller causes the setup information stored in the setup information storing unit to be updated based on the changed setup information stored in the view storing unit.

The controller converts detailed setup information for the setup item into text data and causes the pop-up picture to be displayed as a character-based text picture on the display unit.

The controller causes the pop-up picture on the display unit to be displayed outside the setup information initial picture.

The controller causes the pop-up picture displayed on the display unit to be displayed to be smaller than the setup information initial picture.

The controller causes the setup information initial picture to be displayed to include at least one of a layout tap, a paper tap, a graphic tap, an additional function tap and a driver information tap.

The foregoing and/or other aspects and utilities of the present general inventive concept can be also achieved by providing a control method of an image forming control apparatus, the method including displaying setup information for a plurality of setup items related to image formation and a plurality of individual selection areas for the plurality of setup items in a setup information initial picture on a display unit, placing a pointer on one of the plurality of individual selection areas through a user input unit, and displaying detailed setup information corresponding to a setup item on which the pointer is placed in a pop-up picture of a predetermined format on the display unit, if a preview function is set.

The control method may further include removing the pop-up picture if the pointer is moved out of the individual selection area on which the pointer has been placed through the user input unit.

The displaying of the detailed setup information in the pop-up picture may further include displaying a setup change area in which a user changes the setup information for the setup item through the user input unit.

The control method further may include, if the user changes the setup information in the setup change area, storing the changed setup information in a view storing unit.

The control method may further include displaying a message to request a confirmation for the change of the setup information on the display unit, and, if the user selects the confirmation through the user input unit, updating the setup information stored in a setup information storing unit based on the changed setup information stored in the view storing unit.

The displaying of the detailed setup information in the pop-up picture may further include converting the detailed setup information for the setup item into text data and displaying the pop-up picture as a character-based text picture on the display unit.

The displaying of the setup information in the setup information initial picture may further include activating and displaying at least one of a layout tap, a paper tap, a graphic tap, an additional function tap and a driver information tap in the setup item.

The foregoing and/or other aspects and utilities of the present general inventive concept can be also achieved by providing a control method of an image forming control apparatus, the method including displaying a plurality of individual selection areas corresponding to a plurality of setup items, respectively, in a setup information initial picture, determining an individual selection area within which a pointer is located, identifying whether a preview function is selected, and displaying setup information of the corresponding setup item of the individual selection area that the pointer was located in a pop-up picture of a predetermined format in response to the identifying operation identifying that the preview function has been selected.

The foregoing and/or other aspects and utilities of the present general inventive concept can be also achieved by providing a control method of storing changed setup information of a setup item of an image forming apparatus, the method including displaying a pop-up picture including one or more setup change areas having setup information corresponding to the setup item, determining whether a function to change the setup information displayed in the pop-up picture is selected, identifying the changed setup information in the one or more setup change areas of the pop-up picture, and storing the changed setup information in a storing unit in response to the determination that the function to change the setup information was selected and the identification of the changed setup information.

The method may further include requesting a confirmation to accept changed setup information in response to the changed setup information being stored in the storing operation, and storing the changed information in a setup information storing unit in response to at least one of receiving the confirmation in the requesting operation and an automatic update of the setup information storing unit.

The requesting of the confirmation to accept the changed setup information may include displaying a message to request the confirmation to accept the changed setup information.

The storing unit may include a picture view storing unit.

The foregoing and/or other aspects and utilities of the present general inventive concept can be also achieved by providing an image forming control apparatus including a controller to control a setup information initial picture having a plurality of individual selection areas corresponding to a plurality of setup items relating to image formation, respectively, to be displayed, and a printer driver to drive an image forming apparatus based on setup information, the driver including a setup information storing unit to store the setup information corresponding to the plurality of setup items, wherein the controller displays a pop-up picture of a predetermined format of a first set of information of the setup information for a setup item corresponding to one of the plurality of individual selection areas within which a pointer is located.

The controller may control the pop-up picture to be removed if the pointer is moved out of the one of the plurality of individual selection areas.

The controller may control the pop-up picture to be a smaller size than the setup information initial picture.

The pop-up picture may include a setup change area.

The controller may further include a view storing unit to store the changed setup information, if the setup information is changed in the setup change area.

The pointer may be controlled by a user.

The first set of information may be detailed information of the setup information.

The foregoing and/or other aspects and utilities of the present general inventive concept can be also achieved by providing a user interface apparatus usable with an image forming apparatus, the user interface apparatus including a functioning manager unit to manage a plurality of individual selection areas corresponding to a plurality of setup items, each of the individual selection areas including a tap picture area having tap picture setup information and a menu picture area having main picture setup information, a tap picture setting unit to read the tap picture setup information in a tap picture view storing unit in response to a pointer being located in the tap picture area, a tap picture view displaying unit to convert the tap picture setup information read by the tap picture setting unit and to display the converted tap picture setup information as a tap picture pop-up picture in a predetermined format, a menu picture setting unit to read the main picture setup information in a menu picture view storing unit in response to the pointer being located in the menu picture area, and a menu picture view displaying unit to convert the main picture setup information read by the menu picture setting unit and to display the main picture converted setup information as a main picture pop-up picture in the predetermined format.

The foregoing and/or other aspects and utilities of the present general inventive concept can be also achieved by providing an image forming apparatus including a user input unit having a pointer, a display unit to display information from a user interface, the user interface apparatus including a functioning manager unit to manage a plurality of individual selection areas corresponding to a plurality of setup items, each of the individual selection areas including a tap picture area having tap picture setup information and a menu picture area having main picture setup information, a tap picture setting unit to read the tap picture setup information in a tap picture view storing unit in response to the pointer being located in the tap picture area, a tap picture view displaying unit to convert the tap picture setup information read by the tap picture setting unit and to display the converted tap picture setup information as a tap picture pop-up picture in a predetermined format, a menu picture setting unit to read the main picture setup information in a menu picture view storing unit in response to the pointer being located in the menu picture area, and a menu picture view displaying unit to convert the main picture setup information read by the menu picture setting unit and to display the main picture converted setup information as a main picture pop-up picture in the predetermined format.

The foregoing and/or other aspects and utilities of the present general inventive concept can be also achieved by providing a computer readable recording medium containing computer readable codes as a program to execute an image forming control method of an image forming apparatus, the method including displaying a plurality of individual selection areas corresponding to a plurality of setup items, respectively, in a setup information initial picture, determining an individual selection area within which a pointer is located, identifying whether a preview function is selected, and displaying setup information of the corresponding setup item of the individual selection area that the pointer was located in a pop-up picture of a predetermined format in response to the identifying operation identifying that the preview function has been selected.

The foregoing and/or other aspects and utilities of the present general inventive concept can be also achieved by providing an image forming control apparatus including a controller to generate a setup information initial picture having a plurality of individual selection areas corresponding to a plurality of setup items relating to image formation, and a pointer disposed in the setup information initial picture, and to simultaneously generate a pop-up picture having a set of sub-setup items of the plurality of setup items according to a location of the pointer with respect to the plurality of individual selection areas, and a driver to generate printing data of the image formation according to the set of the sub-set items generated by the controller.

### BRIEF DESCRIPTION OF THE DRAWINGS

These and/or other aspects of the present general inventive concept will become apparent and more readily appreciated from the following description of the embodiments, taken in conjunction with the accompanying drawings of which:

FIG. 1 is a schematic block diagram illustrating an image forming control apparatus according to an exemplary embodiment of the present general inventive concept;

FIG. 2 is a block diagram illustrating a preview managing unit of FIG. 1;

FIG. 3 is a flow chart illustrating a control method of the image forming control apparatus according to the exemplary embodiment of the present general inventive concept;

FIG. 4 is a flow chart illustrating a setup information change function added to the control method of FIG. 3; and

FIGS. 5A to 5C are views illustrating examples of a picture configuration embodied by the image forming control apparatus and the control method thereof according to an exemplary embodiment of the present general inventive concept.

### DETAILED DESCRIPTION OF THE PREFERRED EMBODIMENTS

Reference will now be made in detail to exemplary embodiments of the present general inventive concept, examples of which are illustrated in the accompanying drawings. The embodiments are described below so as to explain the present general inventive concept by referring to the figures.

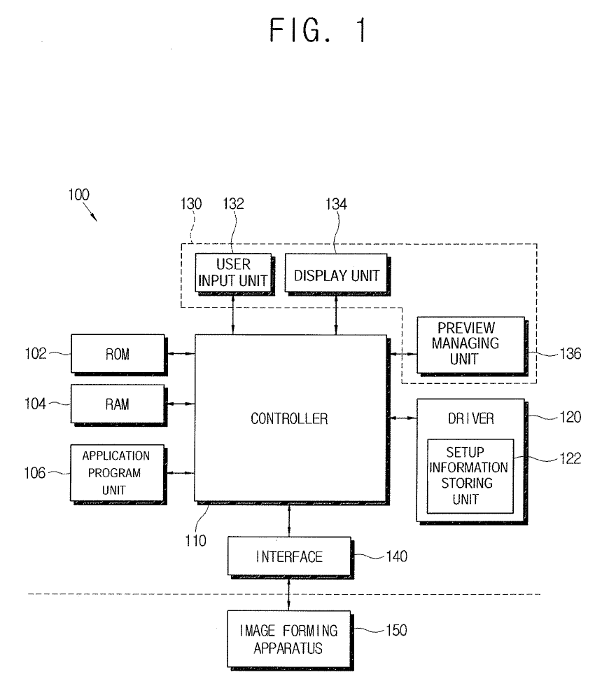

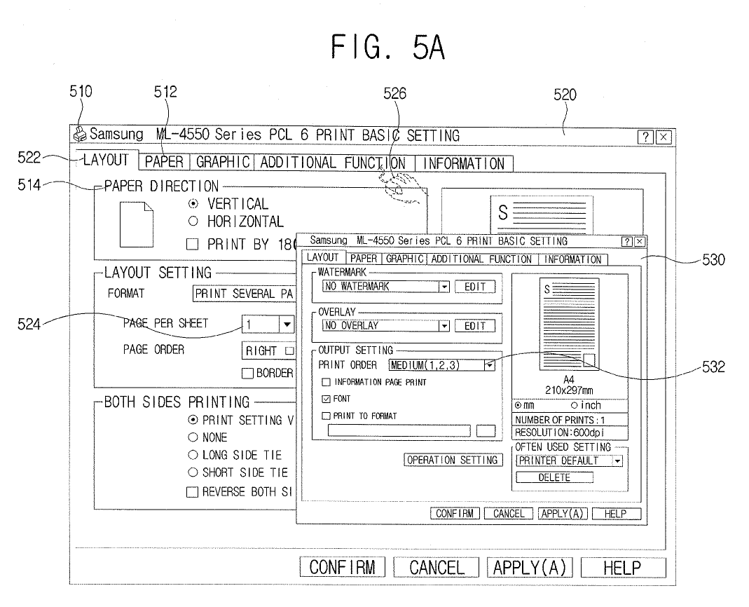

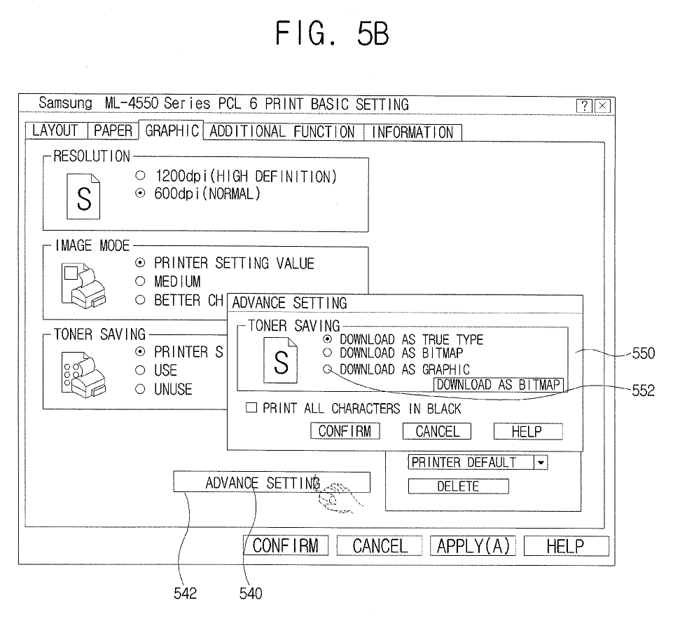

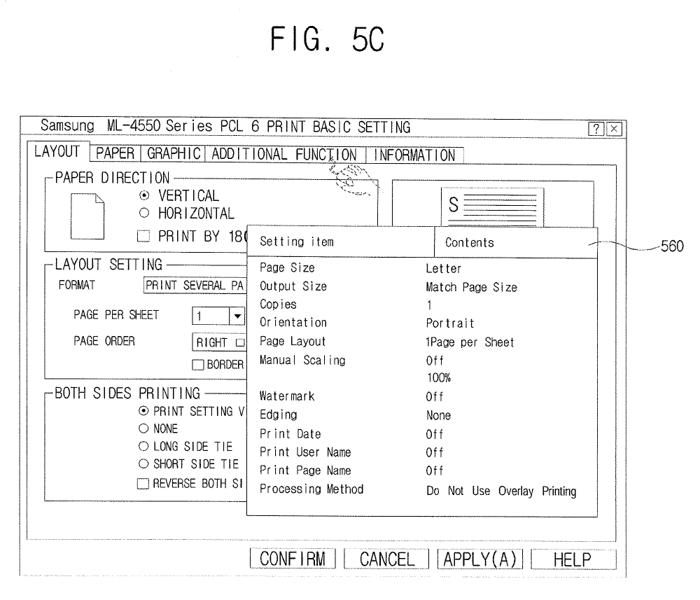

Hereinafter, a configuration of an image forming control apparatus and a control method thereof according to an exemplary embodiment of the present general inventive concept will be described with reference to FIGS. 1 to 4, and examples of a picture configuration will be described with reference to FIGS. 5A to 5C.

FIG. 1 is a schematic block diagram illustrating an image forming control apparatus 100 according to an exemplary embodiment of the present general inventive concept.

As illustrated in FIG. 1, the image forming control apparatus 100 is connected to an image forming apparatus 150 via an interface 140. The interface 140 enables communication between the image forming control apparatus 100 and the image forming apparatus 150 and may have a local connection using a USB (universal serial bus) port or an LPT (line printer) port or a network connection using an IP (Internet Protocol) sharer. The image forming control apparatus 100 may be a personal computer, a network computer, a laptop computer, a portable computer, etc., to control image forming or printing of the image forming apparatus 150.

The image forming control apparatus 100 comprises a ROM 102, a RAM 104, an application program unit 106, a controller 110, a driver 120 and a UI (user interface) 130.

In the ROM 102 are stored various control programs to perform functions of the image forming control apparatus 100, in the RAM 106 are stored programs to be executed by the controller 110 comprising a CPU (not illustrated) and loaded from the ROM 104 or data processed by the controller 110, and, in the application program unit 106 are stored application programs to allow a user to create various kinds of documents.

The driver 120 includes a setup information storing unit 122 in which setup information on a plurality of setup items related to image formation, for example, the number of prints, the kind of paper, printing direction, print quality, etc., is stored. For example, if a document created in an application program of the image forming control apparatus 100 is to be printed by a printer as an example of the image forming apparatus 150, setup information provided by a manufacture company of the printer has to be set in the image forming control apparatus to control a print function of the printer. In addition, to drive the image forming apparatus 150, the driver 120 converts document data provided from the application program unit 106 and the setup information stored in a setup information storing unit 122 into print data, which can be recognized by the image forming apparatus 150.

The UI 130 is an interface to allow the user to select or change the setup information of the driver 120. The UI 130 includes a user input unit 132, a display unit 134 and a preview managing unit 136.

The user input unit 132, which is an input device such as a keyboard, a mouse or the like, selects or changes the setup information displayed on the display unit 134. The display unit 134, which is a display device such as a CRT, an LCD or the like, displays the setup information on the plurality of setup items stored in the setup information storing unit 122 of the driver 120.

Referring to FIGS. 1 and 5A, the preview managing unit 136 is a unit to manage a preview function. Specifically, when the user places a pointer of the user input unit 132 on one of individual selection areas 522 (illustrated in FIG. 5A) for the plurality of setup items 512 (illustrated in FIG. 5A) in a setup information initial picture 520 (illustrated in FIG. 5A) displayed on the display unit 134, the preview managing unit 136 reads detailed setup information of the selected setup item 512 out of the setup information storing unit 122 of the driver 120 and displays the read detailed setup information in a separate pop-up picture 530 (illustrated in FIG. 5A) of a predetermined format on the display unit 134. When the user moves the pointer of the user input unit 132 out of the selected area of the display unit 134, the preview managing unit 136 removes the pop-up picture 530 provided as a preview picture.

The preview managing unit 136 may display the pop-up picture 530 outside the setup information initial picture 520 to allow the user to identify the pop-up picture 530 without difficulty. In addition, the preview managing unit 136 may display the pop-up picture 530 with a size smaller or larger than that of the setup information initial picture 550 to provide a picture of a desired size for the user.

The controller 110, which includes a CPU, a microcomputer or the like, controls the overall operation of the image forming control apparatus 100 according to various control programs stored therein. In particular, in this embodiment of the present general inventive concept, upon receiving a print request signal from the user input unit 132, the controller 110 displays the setup information stored in the driver 120 in the setup information initial picture 520 on the display unit 134. When the user changes setup information 514 (illustrated in FIG. 5A) through the user input unit 132, the controller 110 controls a printing operation based on the changed setup information.

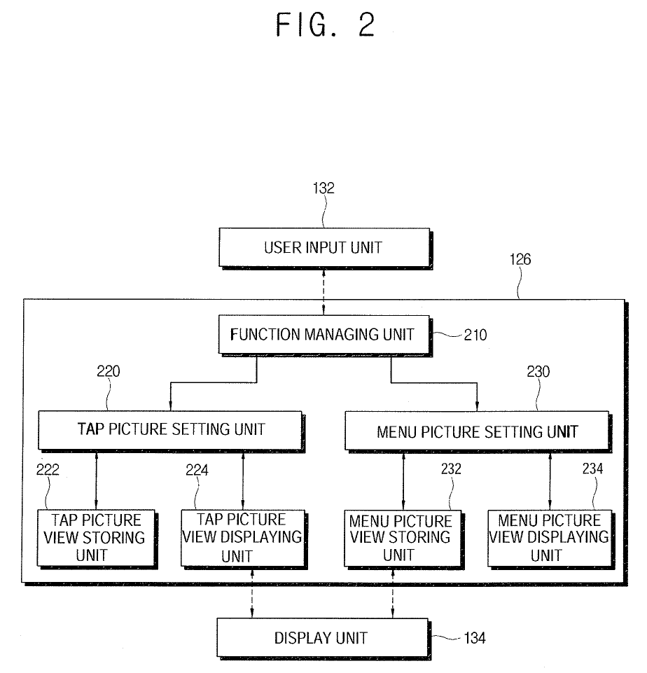

FIG. 2 is a detailed block diagram illustrating a preview managing unit 136 of in FIG. 1.

Referring to FIG. 2, a preview managing unit 136 includes a function managing unit 210, a tap picture setting unit 220, a menu picture setting unit 230, a tap picture view storing unit 222, a menu picture view storing unit 232, and a tap picture view displaying unit 224, and a menu picture view displaying unit 234 to perform a preview function.

Referring to FIGS. 2, 5A and 5B, the function managing unit 210 manages the individual selection areas 522 and 542 for the plurality of setup items of the setup information initial picture 520. The individual selection areas 522 and 542 are divided into a tap picture area 522 in which display of the setup information for each setup item in the setup information initial picture 520 may be changed, and a menu picture area 542 in which an additional setup information picture is displayed in addition to the setup information picture displayed on the display unit 134.

Referring to FIGS. 2, 5A, 5B and 5C, when the user places the pointer of the user input unit 132 on the tap picture area 522 in the setup information initial picture 520, the tap picture setting unit 220 reads the setup information stored in the tap picture view storing unit 222 and displays the read setup information in the pop-up pictures 530 and 560 of the predetermined format on the display unit 134 through the tap picture view displaying unit 224.

When the user places the pointer of the user input unit 132 on the menu picture area 542 in the setup information initial picture 520, the menu picture setting unit 230 reads the setup information stored in the menu picture view storing unit 232 and displays the read setup information in the pop-up picture 550 of the predetermined format on the display unit 134 through the menu picture view displaying unit 234.

Referring to FIGS. 1, 2, 5A, 5B and 5C, the picture view storing units 222 and 232 read and store data provided in the preview function from the setup information storing unit 122 of the driver 120. In particular, when the picture view storing units 222 and 232 store only setup information requiring a user confirmation, the amount of setup information of the pop-up pictures 530, 550 and 560 displayed on the display unit 134 may be reduced. In addition, when the user changes the setup information in the pop-up pictures 530, 550 and 560 as preview pictures, the picture view storing units 222 and 232 temporarily store the changed setup information.

The picture view displaying units 224 and 234 convert the setup information related to a tap picture or a menu picture into one of graphic pictures 530 and 550 and a character-based text picture 560 selected by the user and displays the converted setup information as a pop-up picture on the display unit 134.

Although it has been illustrated in FIG. 1 that the preview managing unit 136 is included in the UI 130, in an embodiment of the present general inventive concept, the preview managing unit 136 may be included in the controller 110 since the preview managing unit 136 has a control function to display a pop-up picture as a preview picture. In addition, although it has been illustrated in this embodiment that the picture view storing units 222 and 232 are configured separately from the RAM 104, in an embodiment of the present general inventive concept, the picture view storing units 222 and 232 may be configured within a partial area of the RAM 104.

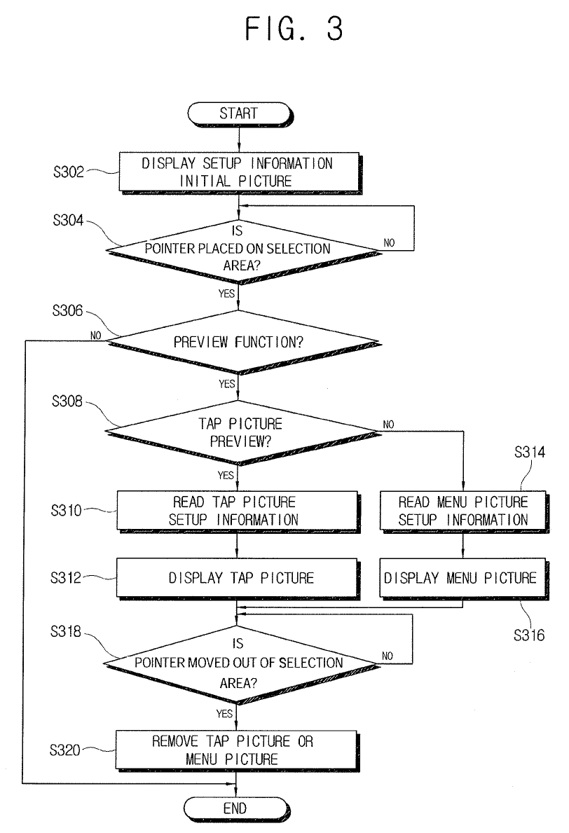

FIG. 3 is a flow chart illustrating a control method of the image forming control apparatus according to the embodiment of the present general inventive concept.

Referring to FIGS. 1, 3 and 5A, upon receiving a print request signal from the user input unit 132, the controller 110 of the image forming control apparatus 100 displays the setup information stored in the driver 120 in the setup information initial picture 520 on the display unit 134 at operation S302. The setup information initial picture 520 includes an information display area 510 in which the type of image forming apparatus 150, for example, Samsung ML-4550, is indicated, individual selection areas 522 in which the plurality of setup items 512 related to the image forming apparatus 150, for example, a layout tap, a paper tap, a graphic tap, an additional function tap, an information tap, etc., can be selected, and a setup change area 524 in which the setup information 514 related to a paper direction, a layout setting, etc., can be selected or changed.

Accordingly, it is determined whether or not a user places the pointer of the user input unit 132 on one of the individual selection areas 522 for the plurality of setup items 512 displayed on the setup information initial picture 520 at operation S304. After placing the pointer of the user input unit 132 on one of the individual selection areas 522, it is determined whether or not a preview function is set in option at operation S306. If the preview function is not set in option and when the user clicks one of the individual selection areas 522 on which the pointer of the user input unit 132 is placed, details of the setup information for a setup item selected in the setup information initial picture 520 are displayed.

Referring to FIGS. 2, 3, 5A, 5B and 5C, if the preview function is set in option, the function managing unit 210 determines whether to display the pop-up pictures 530 and 560 related to tap picture setup information or the pop-up picture 550 related to menu picture setup information at operation S308.

Referring to FIGS. 1-3, 5A, 5B and 5C, it is determined that the pop-up pictures 530 and 560 related to the tap picture setup information is displayed, and, for example, when a pointer 526 of the user input unit 132 is placed on the selection area (tap picture area 522) for an additional function, as illustrated in FIGS. 5A and 5C, the tap picture setting unit 220 reads details of the setup information for the selected additional function from the setup information storing unit 122 of the driver 120 or the tap picture view storing unit 222 of the preview managing unit 136 at operation S310. Then, the tap picture setting unit 220 displays the read setup information in the pop-up pictures 530 and 560 on the display unit 134 through the tap picture view displaying unit 224 at operation S312.

The tap picture view displaying unit 224 may display the setup information in the graphic picture 530 on the display unit 134 by processing the setup information by graphic to the same as the setup information initial picture 520, or display the setup information in the character-based text picture 560 on the display unit 134 by converting the setup information into text data. Also, in connection with the display of the pop-up pictures 530 and 560, the user may set a starting position on the basis of the position of the setup information initial picture. In this embodiment of the present general inventive concept, for example, the pop-up pictures 530 and 560 are displayed outside the setup information initial picture so that the pop-up pictures 530 and 560 do not overlap the setup information initial picture.

If it is determined at the operation S308 that the pop-up picture 550 related to the menu picture setup information is displayed, and, for example, when the pointer 526 of the user input unit 132 is placed on the selection area (menu picture area) 542 for an advance setting 540, as illustrated in FIG. 5B, the menu picture setting unit 230 reads details of the setup information for the selected advanced settings from the setup information storing unit 122 of the driver 120 or the menu picture view storing unit 232 of the preview managing unit 136 at operation S314, and then, displays the read setup information in the pop-up picture 550 on the display unit 134 through the menu picture view displaying unit 234 at operation S316.

Accordingly, it is determined whether or not the user moves the pointer 526 of the user input unit 132 out of the selection areas 522 and 542 at operation S318, and, if it is determined that the pointer 526 is moved out of the selection areas 522 and 542, the pop-up pictures 530, 550 and 560 are removed at operation S320. Alternatively, the pop-up pictures 530, 550 and 560 may be programmed to be automatically removed after elapse of a predetermined period of time or when the pointer 526 of the user input unit 132 is moved to a different selection area.

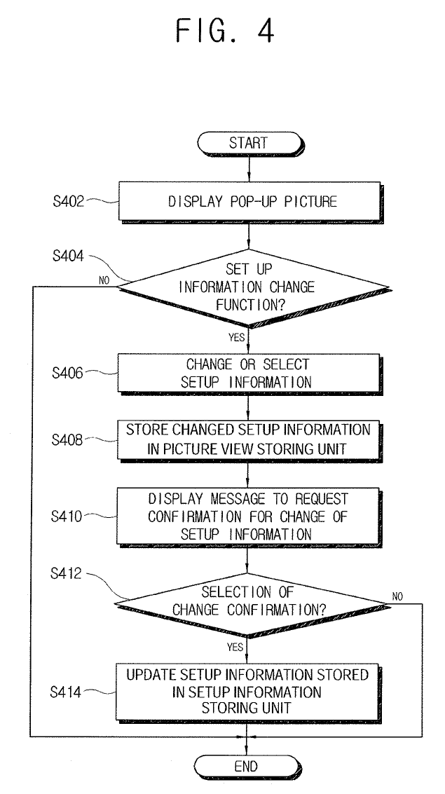

FIG. 4 is a flow chart illustrating a setup information change function added to the control method of FIG. 3. The setup information change function of FIG. 4 may be performed after the operation S312 or S316 of FIG. 3 to change, select, or update the setup information.

Referring to FIGS. 1, 4, 5A and 5B, when the user places the pointer 526 of the user input unit 132 on the selection areas 522 and 542, the preview managing unit 136 displays the pop-up pictures 530 and 550 to display the preview function of the setup information for relevant setup items on the display unit 134 at operation S402. In the displayed pop-up pictures 530 and 550 are provided setup change areas 532 and 552 in which the user may change the setup information through the user input unit 132.

The preview managing unit 136 determines whether or not a function to change the setup information displayed in the pop-up pictures 530 and 550 is set at operation S404. If it is determined that the setup information change function is set, the user may place the pointer 526 of the user input unit 132 on the setup change areas 532 and 552 to change required setup information, or may place the pointer 526 of the user input unit 132 on the setup change areas 532 and 552 and then click to select required setup information at operation S406.

Accordingly, the setup information is changed or selected in the pop-up pictures 530 and 550 to display the preview function of the setup information for relevant setup items, the changed or selected setup information is stored in the picture view storing units 222 and 232 at operation S408. However, if there is no change to the setup information, the setup information remains unchanged.

When the changed or selected setup information is stored in the picture view storing units 222 and 232, the preview managing unit 136 displays a message to request a confirmation for the change or selection of the setup information on the display unit 134 at operation S410. Specifically, when the setup information changed or selected in the pop-up pictures 530, 550 and 560, illustrated in FIGS. 5A, 5B and 5C, is stored in the picture view storing units 222 and 232, and when a signal to remove the pop-up pictures 530, 550 and 560 is generated, in an embodiment of the present general inventive concept, for example, the preview managing unit 136 displays the message to request the confirmation of updating the setup information stored in the setup information storing unit 122 by the changed or selected setup information.

Accordingly, based on the message displayed on the display unit 134, when the user selects a change confirmation through the user input unit 132 at operation S412, the setup information stored in the setup information storing unit 122 of the driver 120 is updated to the changed or selected setup information stored in the picture view storing units 222 and 232 at operation S414.

Alternatively, according to an option set by the user, the setup information stored in the setup information storing unit 122 of the driver 120 may be automatically updated to the changed or selected setup information stored in the picture view storing units 222 and 232 without selection of a confirmation button.

The present general inventive concept can also be embodied as computer-readable codes as a program to execute an image forming control method on a computer-readable recording medium. The computer-readable recording medium is any data storage device that can store data which can be thereafter read by a computer system. Examples of the computer-readable recording media include read-only memory (ROM), random-access memory (RAM), CD-ROMs, magnetic tapes, floppy disks, optical data storage devices, and carrier waves (such as data transmission through the Internet). The computer-readable recording medium can also be distributed over network-coupled computer systems so that the computer-readable code is stored and executed in a distributed fashion. Also, functional programs, codes, and code segments to accomplish the present general inventive concept can be easily construed by programmers skilled in the art to which the present general inventive concept pertains.

As apparent from the above description, the present general inventive concept provides an image forming control apparatus allowing a user to simply and quickly confirm setup information for a plurality of setup items related to image formation, and a control method thereof.

In addition, the present general inventive concept provides an image forming control apparatus allowing a user to change setup information of a driver in a preview function, and a control method thereof.

Although a few embodiments of the present general inventive concept have been illustrated and described, it will be appreciated by those skilled in the art that changes may be made in these embodiments without departing from the principles and spirit of the general inventive concept, the scope of which is defined in the appended claims and their equivalents.

What is claimed is:

1. An image forming control apparatus comprising:
a display unit;
a user input unit that allows a user to move a pointer on a picture displayed on the display unit;
a printer driver that includes a setup information storing unit to store setup information for a plurality of setup items related to image formation, and to drive an image forming apparatus based on the setup information; and
a controller to control a setup information initial picture having a plurality of individual selection areas for the plurality of setup items to be displayed on the display unit, and to control details of the setup information corresponding to a setup item to be displayed in a pop-up picture of a predetermined format on the display unit if the user places the pointer on one of the plurality of individual selection areas through the user input unit.

2. The image forming control apparatus according to claim 1, wherein the controller causes the pop-up picture to be removed if the user moves the pointer out of the individual selection area on which the pointer has been placed.

3. The image forming control apparatus according to claim 1, wherein the pop-up picture, further comprises:
a setup change area in which the user changes the setup information for the setup item through the user input unit.

4. The image forming control apparatus according to claim 3, wherein the controller, further comprises:
a view storing unit, and, if the user changes the setup information in the setup change area, the controller stores the changed setup information in the view storing unit.

5. The image forming control apparatus according to claim 4, wherein the controller causes a message to request a confirmation for the change of the setup information to be displayed on the display unit, and, if the user selects the confirmation through the user input unit, the controller causes the setup information stored in the setup information storing unit to be updated based on the changed setup information stored in the view storing unit.

6. The image forming control apparatus according to claim 1, wherein the controller converts detailed setup information for the setup item into text data and causes the pop-up picture to be displayed as a character-based text picture on the display unit.

7. The image forming control apparatus according to claim 1, wherein the controller causes the pop-up picture on the display unit to be displayed outside the setup information initial picture.

8. The image forming control apparatus according to claim 1, wherein the controller causes the pop-up picture displayed on the display unit to be displayed to be smaller than the setup information initial picture.

9. The image forming control apparatus according to claim 1, wherein the controller causes the setup information initial picture to be displayed to include at least one of a layout tap, a paper tap, a graphic tap, an additional function tap and a driver information tap.

10. A control method of an image forming control apparatus comprising:
displaying setup information for a plurality of setup items related to image formation and a plurality of individual selection areas for the plurality of setup items in a setup information initial picture on a display unit;
placing a pointer on one of the plurality of individual selection areas through a user input unit; and
displaying detailed setup information corresponding to a setup item on which the pointer is placed in a pop-up picture of a predetermined format on the display unit, if a preview function is set.

11. The control method according to claim 10, further comprising removing the pop-up picture if the pointer is moved out of the individual selection area on which the pointer has been placed through the user input unit.

12. The control method according to claim 10, wherein the displaying the detailed setup information in the pop-up picture further comprises displaying a setup change area in which a user changes the setup information for the setup item through the user input unit.

13. The control method according to claim 12, further comprising, if the user changes the setup information in the setup change area, storing the changed setup information in a view storing unit.

14. The control method according to claim 13, further comprising displaying a message to request a confirmation for the change of the setup information on the display unit, and, if the user selects the confirmation through the user input unit, updating the setup information stored in a setup information storing unit based on the changed setup information stored in the view storing unit.

15. The control method according to claim 10, wherein the displaying the detailed setup information in the pop-up picture comprises converting the detailed setup information for the setup item into text data and displaying the pop-up picture as a character-based text picture on the display unit.

16. The control method according to claim 10, wherein the displaying the setup information in the setup information initial picture comprises activating and displaying at least one of a layout tap, a paper tap, a graphic tap, an additional function tap and a driver information tap in the setup item.

17. A control method of an image forming control apparatus, the method comprising:
displaying a plurality of individual selection areas corresponding to a plurality of setup items, respectively, in a setup information initial picture;
determining an individual selection area within which a pointer is located;
identifying whether a preview function is selected; and
displaying setup information of the corresponding setup item of the individual selection area that the pointer was located in a pop-up picture of a predetermined format in response to the identifying operation identifying that the preview function has been selected.

18. An image forming control apparatus comprising:
a controller to control a setup information initial picture having a plurality of individual selection areas corresponding to a plurality of setup items relating to image formation, respectively, to be displayed; and
a printer driver to drive an image forming apparatus based on setup information, the driver including a setup information storing unit to store the setup information corresponding to the plurality of setup items;
wherein the controller displays a pop-up picture of a predetermined format of a first set of information of the setup information for a setup item corresponding to one of the plurality of individual selection areas within which a pointer is located.

19. A user interface apparatus usable with an image forming apparatus, the user interface apparatus comprising:
a functioning manager unit to manage a plurality of individual selection areas corresponding to a plurality of setup items, each of the individual selection areas including a tap picture area having tap picture setup information and a menu picture area having main picture setup information;
a tap picture setting unit to read the tap picture setup information in a tap picture view storing unit in response to a pointer being located in the tap picture area;
a tap picture view displaying unit to convert the tap picture setup information read by the tap picture setting unit and to display the converted tap picture setup information as a tap picture pop-up picture in a predetermined format;
a menu picture setting unit to read the main picture setup information in a menu picture view storing unit in response to the pointer being located in the menu picture area; and
a menu picture view displaying unit to convert the main picture setup information read by the menu picture setting unit and to display the main picture converted setup information as a main picture pop-up picture in the predetermined format.

20. A computer readable recording medium containing computer readable codes as a program to execute an image forming control method of an image forming apparatus, the method comprising:
displaying a plurality of individual selection areas corresponding to a plurality of setup items, respectively, in a setup information initial picture;
determining an individual selection area within which a pointer is located;
identifying whether a preview function is selected; and
displaying setup information of the corresponding setup item of the individual selection area that the pointer was located in a pop-up picture of a predetermined format in response to the identifying operation identifying that the preview function has been selected.
